(19) United States
(12) Patent Application Publication
(10) Pub. No.: US 2017/0219731 A1
(43) Pub. Date: Aug. 3, 2017

(54) METHOD OF VISUALIZING AND INTERPRETING WIDE AZIMUTH PROFILE (WAP)

(71) Applicant: P-Cable 3D Seismic AS, Oslo (NO)

(72) Inventors: Ola Kaas ERIKSEN, Oslo (NO); Sverre PLANKE, Oslo (NO); Henrik Henriksen STOKKE, Oslo (NO)

(21) Appl. No.: 15/419,557

(22) Filed: Jan. 30, 2017

(30) Foreign Application Priority Data
Feb. 2, 2016 (NO) 20160161

(51) Int. Cl. G01V 1/34; G01V 1/38

(52) U.S. Cl. CPC G01V 1/345; G01V 1/38; G01V 2210/642; G01V 2210/165

(57) ABSTRACT

A data visualization method for visualizing data acquired along a non-linear acquisition path or sail line. The data consists of CMP lines that follow the non-linear acquisition path. The data is arranged such that the in-lines in the binning grid follow the acquisition path and the cross-lines are perpendicular, or near perpendicular, to the in-lines, the method comprising the steps of: creating a binning grid covering the CMP lines of the acquired data, the binning grid comprising a straight portion and a curved portion; calculating bins for each portion; loading the seismic data into the a visualization software; and creating a set of linked windows, wherein a field of view of the different set of linked windows is synchronized, and wherein a marker is provided to visualize the field of view of data in at least two of the linked windows.

### CROSS-REFERENCE TO RELATED APPLICATION

This application claim the benefit of priority to Norwegian Patent Application No. 20160161, filed Feb. 2, 2016. The disclosure of the prior application is hereby incorporated in its entirety by reference.

### FIELD OF THE INVENTION

The invention concerns visualization and interpretation of wide azimuth profiling, as set out by the preamble of Claim 1.

### BACKGROUND OF THE INVENTION

Imaging of geological structures is important for a number of applications, both industrial and academic. Seismic data acquisition is a survey method which is used both on land and in marine environments. In marine seismic data acquisition, geology of structures underlying a body of water is imaged using one or more surface vessels equipped with one or more acoustic sources and one or more streamer cables.

The source generates energy, called a seismic signal, which travels through the water column in all directions. The portion of the energy that travels downward towards the seafloor and underlying geological structures is partly reflected from the different geological structures in the subsurface. The strength of the reflection is given by the change in acoustic impedance over the reflective surface. The reflected signal that travels upward is recorded by the streamer cables towed behind the surface vessel.

The image of the geology is generated based on the time it takes the seismic signal to travel from the source and down to the reflective surfaces and back up to the streamer cables, the positions of the source and the receivers in the streamer cable, and the speed of sound in the different media the signal travels through. The actual position of the reflection in the subsurface is calculated using a mathematical method based on the wave equation to migrate the seismic signal to a set of coordinates and depth.

The acquisition setup can consist of one or more energy sources. The dominating type of source for marine seismic surveys is air guns that generate a signal by creating an air bubble from compressed air that collapses in the water column. Other sources can be sparkers, boomers and vibrators. The source can be towed from the same vessel as the streamer cables or from one or more separate source vessels. The source is normally fired at a regular interval, this interval is set based on the receiver distance in the streamer cables, number of receivers, towing speed, source type, target depth and desired data density. When the source is fired it is called a shot.

The streamer cables towed behind marine seismic acquisition vessels contain transducers called hydrophones that transform the seismic signal into electromagnetic signals. The hydrophones are distributed along the cable and are often arranged into groups acting as a single receiver. The number of receivers and the distance between them on the cable will vary between different streamer types and desired data properties. The length of the streamer cables vary from only a few meters long (˜10 m) or even just a point receiver for some high-resolution systems, to several kilometer (up to 12 km or more) long streamers for large systems.

For each shot every receiver records an acoustic record called a trace. Each trace has a common midpoint (CMP) which is the middle point between the source and the receiver and is regarded as the position of the measured reflections in the trace. This will however be subject to corrections later in the processing for dipping reflectors etc. For systems with longer streamers there are many traces with approximately the same CMP position. The traces can be collated to form what is known as a gather, in this case a CMP gather. The number of traces that make up a gather is referred to as the fold of the gather

Marine 2D seismic data acquisition makes use of a single towed streamer behind a surface vessel and one or more sources. The data is generally acquired along a linear acquisition path, it can however contain turns. The 2D seismic data acquisition is useful for acquiring regional data covering large areas in a relatively inexpensive way. However, it does have the limitation of only containing information along one line. The result is a single cross section of the subsurface with no spatial information.

2D data is normally processed and arranged as shot points, which are CMP gathers that each have coordinates along a single line. This line can be loaded into interpretation software and visualized as a vertical section showing the cross section of the subsurface.

Marine 3D seismic data acquisition utilizes several parallel towed streamers behind a surface vessel and one or more sources. The data is generally acquired along parallel linear lines predefined in a pattern which gives a total coverage of the subsurface. The number and the length of the streamer cables used for 3D acquisition depend on the size of the area to be surveyed and the target to be imaged. The number of streamers might vary from 2 to 24 or more streamers, with length variations from 10 m or less to 12 km or more. The individual distance between the streamers may vary from very short, less than a meter, for some ultra-high-resolution systems, to 100 m or more for some large conventional systems. 3D seismic data acquisition is useful when there is a need for a full three-dimensional overview of the subsurface structure. A 3D data volume gives the ability to view the data not only as vertical sections (cross sections) along or parallel to the acquisition path but also vertical sections perpendicular to the acquisition path and in any other direction. The data can also be viewed from a bird's perspective either as time-slices or as horizons that are interpreted along a reflection surface within the data volume. The three-dimensional nature of the data also makes it possible to collapse the reflected seismic signal more accurately to the actual reflection point during a processing step called migration.

The data processing steps of organizing traces in bins is called “binning”. A bin may contain many traces from source-receiver pairs. Azimuth is angle for a particular source-receiver pair referred as the angle defined between the line along which the source-receiver pair lies and an arbitrarily selected direction such as true north or east.

3D data is normally acquired along linear parallel lines to give as regularly sampled data as possible. This is beneficial when the data is processed and arranged into bins which lie along a regular and rectangular grid. During acquisition, each of the streamers in a 3D system will generate a line of CMP positions similar to that of a 2D system. One swath acquired along one sail-line with a 3D system thus contains the same number of CMP lines as the number of parallel streamers used in the 3D system. However, if more than one source is used in a so-called flip flop shooting setup, each streamer will generate one line of CMP positions per source. In processing, a grid is created over the acquisition area. The quadrangles of this grid are called bins. The size of the bins will determine the horizontal resolution of the data volume and also how many CMP positions (traces) that falls into each bin (the fold of the data). The bins have a length in the in-line direction and a length in the cross-line direction. These lengths can either form square or rectangular bins dependent on the parameters of the acquired data. The in-line direction of a data volume is normally defined as parallel to the acquisition direction, and the cross-line direction perpendicular to the acquisition direction, and in-lines and cross-lines are defined to follow the regular/rectangular grid the data volume is binned onto. The volume consisting of these bins can be loaded into interpretation software where the data can be visualized. The standard way of visualizing the data is in vertical sections along the in-lines and cross-lines, but data can also be visualized along an arbitrary line put in manually. 3D data can also be visualized as time-slices, which is a top view of the volume at a given depth, or as interpreted horizons along reflection surfaces. A 3D view where both in-lines, cross-lines, time slices and horizons, as well as parts of the data volume, can be visualized simultaneously is also common with 3D data.

A method of conducting a marine seismic survey is described in WO 2011057324 A1.At least one traverse comprises: a) sailing a single survey vessel along an oscillating advancing path, the path having a nominal wavelength and a nominal amplitude, the survey vessel towing a marine seismic spread comprising; i) a first source laterally displaced from the port side quarter of the survey vessel; ii) a second source laterally displaced from the starboard side quarter of the survey vessel, and, iii) a marine seismic streamer including a plurality of acoustic receivers, wherein the length of the streamer is selected to be at least equal to the distance travelled by the survey vessel as it sails along one full wavelength of the oscillating advancing path; b) alternating shooting between the first source and the second source; and, c) recording acoustic reflections from one or more sub-sea geologic features using the plurality of acoustic receivers.

An acquisition campaign would often benefit from having the ability to acquire both 2D and 3D data to maximize the cost/benefit ratio. An example of this are recent surveys in the Barents Sea (2012-2015) where the P-Cable high-resolution 3D seismic system has been used to acquire both high-resolution 3D volumes and regional long lines of data processed as 2D data. In this case the acquisition is based on the high-resolution P-Cable system which consists of several short streamers, in this example 16 streamers, each 25 meter long. The streamers are in this example spaced 12,5 meters apart so the system produces a swath of data for each sail line consisting of 16 parallel CMP lines spaced 6.25 meters apart. This setup produces high-resolution 3D volumes but has a limited daily coverage compared to large conventional 3D systems with up to 24 streamers spaced 100 meters apart. To be able to cover both smaller areas with high-resolution 3D data and larger areas with regional data with the same acquisition system, a non-linear line covering interesting features and wells in a larger regional area was predefined. The vessel towed the P-Cable system and the source along this predefined line, and since the P-Cable system is a 3D system, it produced a swath of 16 CMP lines instead of one CMP line which a common 2D system would.

The data was processed such that all the 16 CMP lines where collapsed together to form a single 2D line. The benefit of this is that the fold becomes very high, which gives a high signal to noise ratio. It is also easier to process and visualize the data. However, the cross line information that the data originally contained got lost. The dataset is really a narrow 3D volume that is acquired along a non-linear acquisition path and by applying a new way of arranging/binning and visualizing seismic data one could benefit from the 3D information that is actually acquired.

FIG. 5 illustrates the problem with processing the narrow 3D volumes which are acquired along a non-linear acquisition path in the same manner as normal 3D datasets, in which the normal 3D data is binned onto a regular/rectangular grid. A long non-linear narrow swath requires a potentially very large grid to allow for this type of binning. This grid contains almost only empty bins which is an impractical solution for several reasons. Because the data in this case is of very high resolution the total number of bins is very large.

Another problem when binning these narrow datasets onto regular grids is how it is visualized in interpretation software where the visualization is based along the in-lines and cross-lines of a regular grid, this problem is shown in FIG. 6. To visualize a whole line in this case it is necessary to manually create an arbitrary line, and there would not be a way to easily toggle between the 16 individual lines without making new arbitrary lines each time.

The WAP data is not particularly well suited for visualization and interpretation in available interpretation software for a number of reasons. The shortcomings makes the data impractical and inefficient to both visualize and interpret, and to be able to utilize the WAP data to its full potential the described invention could be implemented into interpretation software.

Loading of 3D seismic data is generally done along rectangular grids with a fixed bin size and fixed in-line and cross-line directions. Interpretation software which visualizes the WAP data should be modified to be able to load and display the WAP data such that the in-lines can be displayed in their whole length without making arbitrary lines, and also take into account the different bin sizes along a WAP swath when doing calculations. Also, top view of the WAP data should be possible both as time slices and interpreted horizons.

The nature of the WAP data sets, where some datasets could be very narrow and some could be very long, requires a special set of visualization tools to extract both the regional overview and detailed structural information. To utilize the 3D information which is contained in these data sets, a zoom window which can zoom in to a field of view in the range of a couple of hundred meters is required. This will, however, not provide any overview or information about larger structures. To be able to effectively interpret the WAP data, a set of linked windows is desirable. With windows which are not linked, the interpreter must zoom in and out for every interpreted detail to be able to keep the overview of the general structures. This results in a very ineffective work flow for interpreting WAP data in conventional interpretation software.

To effectively visualize and interpret the 3D structural attributes extracted from WAP data, visualization tools should be included in both the vertical panels and the map view display. As the width of the WAP data in most cases is very small compared to the length, it can be challenging to properly visualize the interpreted 3D attributes when viewing the data at a regional scale, either in vertical panels or in map view. The lack of linked 3D attribute visualization windows which can visualize interpreted 3D attributes like strike and dip of faults in vertical in-line, cross-line panels or in map view makes common interpretation of such data ineffective.

### SUMMARY OF THE INVENTION

The invention is set forth and characterized in the main claim, while the dependent claims describe other characteristics of the invention.

It is thus provided a method for visualizing data acquired along a non-linear acquisition path or sail line. The data consists of CMP lines that follow the non-linear acquisition path. The data is arranged such that the in-lines in the binning grid follow the acquisition path and the cross-lines are perpendicular, or near perpendicular, to the in-lines, the method comprising the steps of;
creating a binning grid covering the CMP lines of the acquired data, the binning grid comprising a straight portion and a curved portion;
calculating bins for each portion;
loading the seismic data into the a visualization software;
creating a set of linked windows, where a field of view of the different set of windows is synchronized, and wherein a marker is provided to visualize the field of view of data in at least two of the linked windows.

In one aspect of the invention the set of linked windows show a horizontal and a vertical seismic data section, seismic data horizons and time slices, seismic data 3D view and 3D attributes. In the vertical section there is provided a panel for displaying the seismic 3D attributes.

In another aspect of the invention the seismic 3D attributes comprise manually or automatically interpreted 3D properties. The panel (33) displays fault properties, or properties characterizing other seismic attributes or structures., the fault properties include fault offset, strike, dip, depth and age.

In another aspect of the invention the non-linear data is displayed in full length. In another aspect of the invention the non-linear data is multi-beam data or Sub Bottom Profiler data.

In another aspect of the invention there is provided a seismic data visualization method for visualizing seismic data acquired using a vessel (14); a seismic acquisition system for collecting geophysical seismic data; a marine navigation system for generating positioning data from the location of said vessel and the location of said seismic acquisition system; a seismic data storage engaged with the seismic acquisition system for collecting and storing the seismic data; a seismic data processor engaged with said seismic data storage for seismic processing of the seismic data; wherein the seismic data has been acquired along a non-linear acquisition path or sail line. The data consists of CMP lines that follow the non-linear acquisition path. The data is arranged such that the in-lines in the binning grid follow the acquisition path and the cross-lines are perpendicular, or near perpendicular, to the in-lines at any given point, the method further comprising;
creating a binning grid covering the CMP lines of the acquired data, the binning grid comprising a straight portion and a curved portion;
calculating bins for each portion;
loading the seismic data into the a visualization software;
creating a set of linked windows, wherein a field of view of the different set of windows is synchronized, and wherein a marker is provided to visualize the field of view of data in at least two of the linked windows.
Displaying interpreted seismic features on a panel in at least one of the said linked windows.

In another aspect of the invention there is provided a machine with a readable storage medium using a program of instructions executable by the machine, to perform method according to the invention.

### BRIEF DESCRIPTION OF THE DRAWINGS

These and other characteristics of the invention will become clear from the following description of a preferential form of embodiment, given as a non-restrictive example, with reference to the attached schematic drawings, wherein:

FIG. 1a shows a vessel towing a 3D seismic acquisition system acquiring a WAP swath of several in-lines along a non-linear acquisition path.

FIG. 1b shows binning of the WAP swath.

FIG. 2 shows different linked visualization windows.

FIG. 3a shows a set of linked zoom inn windows 8.

FIG. 3b shows a vertical panel.

FIG. 4 shows map window.

FIG. 5: Shows a WAP swath binned onto a rectangular grid in the same manner as conventional 3D data.

FIG. 6: Shows visualization of the problem of a WAP swath that is binned onto a rectangular grid.

### DETAILED DESCRIPTION OF A PREFERENTIAL EMBODIMENT

The following description may use terms such as “horizontal”, “vertical”, “lateral”, “back and forth”, “up and down”, “upper”, “lower”, “inner”, “outer”, “forward”, “rear”, etc. These terms generally refer to the views and orientations as shown in the drawings and that are associated with a normal use of the invention. The terms are used for the reader's convenience only and shall not be limiting.

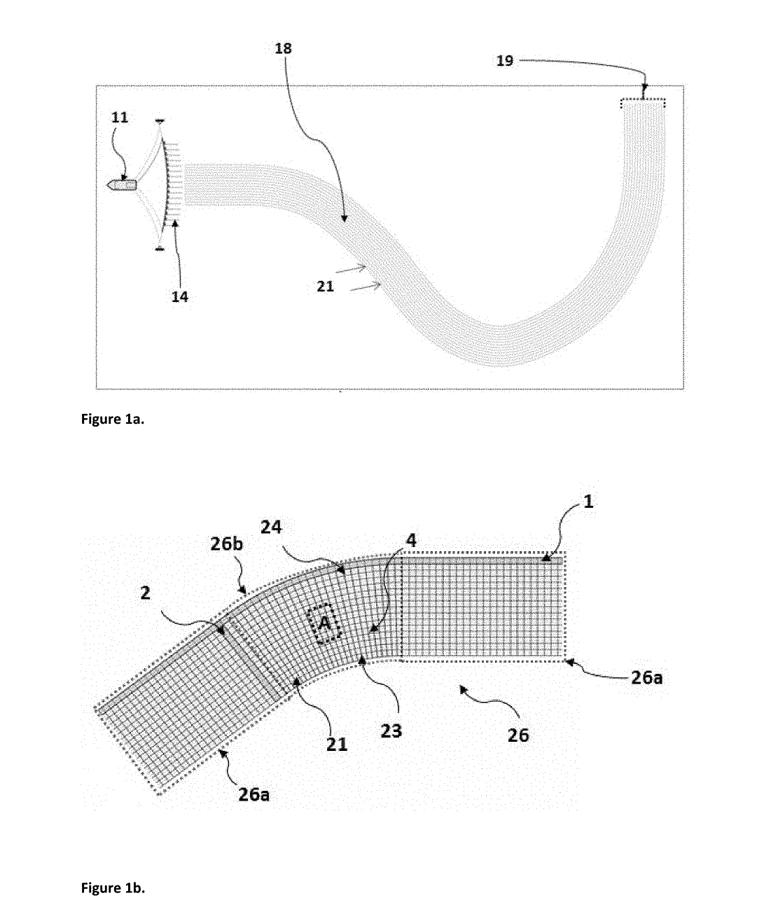

FIG. 1a shows a seismic vessel 11 towing a 3D seismic acquisition system with several streamers 14 in non-linear WAP swath 18 manner. The WAP swath 18 has a width 19 and consists of several CMP lines 21. The seismic data is acquired along a non-linear acquisition path such that the in-lines 1 always are parallel to the acquisition path and the cross-lines 2 are perpendicular to the in-lines 1. This is in contrast to the standard method where the in-lines and cross-lines are linear and lie along a regular and rectangular grid.

Based on the layout of the acquisition system and desired resolution as shown in FIG. 1a and 1b, a bin 4 size is chosen. The bin 4 width will typically be equal to the distance between CMP lines 21 created by the individual streamers 14, but not limited to this width and can be wider or narrower to give the dataset other properties. The bin 4 length may also vary dependent on how many CMP points falls into each bin. The bin 4 length may be shorter, longer or equal to the bin width. Each bin 4 is given a center coordinate. All the centre coordinates 5 of the bins 4 making up a single cross-line lie on a linear line which is normal to the in-lines it crosses at the crossing points. The centre coordinates 5 making up an individual in-lines 1 lie along a line parallel to the acquisition path, this line is not necessarily a straight line. All the individual in-lines 1 are parallel to each other. As such, a binning grid 26 is created which will be rectangular when the acquisition path is linear, and the binning grid 26 will be curved if the acquisition path is curved. In the curved parts of the WAP grid 26b the bin size will not be the same along the individual cross-lines 2. The center bins 4 of the individual cross lines 2 that forms the centre in-line 1 will have the same bin size in both the linear and curved portions of the WAP swath 26, while the “inner” bins 23 taking the shorter path in the curved parts of the grid 26b will be shorter and the “outer” bins 24 taking the longer path in the curved parts of the grid 26b will be longer. The bins along the cross-lines in the linear part of the WAP grid 26a will be approximately equal in size. All the bins will have approximately the same width.

Each CMP point on a CMP line 21 will be assigned to a bin 4, typically the closest one, but not necessarily. The number of CMP's assigned to each bin 4 is defined as the fold of the bin 4. Each bin 4 will typically have an in-line 1 and a cross-line 2 number, a set of coordinates, a bin width and length and an azimuth value, among other values.

The WAP data is processed in such a way that the binning grid and thus the in-lines follow the acquisition path regardless of shape. When the WAP data is loaded into interpretation software, the binning of the WAP data allows the interpretation software to visualize the in-lines in their whole length and easily toggle between all the different in-lines and cross-lines in the dataset even in the curved portions. The interpretation software will then need the ability to display and calculate attributes in in-lines, cross-lines and data volumes that contain bins of unequal sizes. The in-lines towards the sides of the acquired swath have a different bin length in the curved portions of the swath compared to the bins at the linear portions. The calculation of 3D attributes and visualization of zoom inn top views such as time slices and horizon views can be done with the original WAP data binned onto the WAP binning grid. Alternatively, the WAP data can locally be projected onto a rectangular grid allowing the interpretation software to take advantage of standard algorithms assuming a grid with linear in-lines and cross-lines and equal bin sizes. The data may after the processing be projected back onto the WAP binning grid. Both the field of view of the zoom windows and the physical extent of the 3D structural attributes to be calculated will be limited to a few hundred meters along the acquisition path. This will keep the computing power needed to regularize the data to fit onto a regular grid locally relatively small.

To utilize the 3D information in the WAP datasets effectively, a set of linked interpretation windows has proved to be beneficial. The datasets can be less than 50 meters wide, and as such, in order to obtain the cross-line information, a zoom window with a field of view of only a couple of hundred meters is needed. Such a powerful zoom will provide limited overview over larger structures and will be difficult to use effectively.

### LOADING OF WAP DATA

The WAP data is loaded with positions based on the actual centre coordinates for each bin, instead of coordinates based on a rectangular grid. This gives the advantage that in-lines can be displayed in their whole length, even when not linear. However, there are also some issues that need to be overcome before calculations of 3D attributes etc. can be conducted from the data. As described, a layout with a rectangular grid 20 is impractical for the WAP data for several reasons, therefore the data is binned on a WAP grid 26 which follows the actual WAP swath 18 and not a rectangular grid 20. Interpretation software, however, assumes that 3D data is on a regular grid for certain calculations and visualizations, and so a local transformation of the binning of the WAP data is required for some of the calculations and visualizations.

The width of a WAP swath is generally very narrow compared with the length of the profile. Therefore, the part of the WAP swath is used to perform calculations of a 3D attribute, or visualize the swath in 3D or horizontal view, is limited. Even though the data is loaded into the interpretation software on its own WAP grid 26, the data may locally be projected onto a rectangular and regular grid 20 when it is opened in either a 3D window or horizontal view window, or a 3D attribute is to be calculated. Due to the narrow width and hence the small area, the amount of data to be projected when a 3D or horizon window is open is modest, and so the projection can be instant when the windows are opened. When the interpreter is navigating the data the projection is recalculated and visualized in a new area. As such, the interpretation software may take advantage of the already well developed algorithms assuming 3D data on a rectangular grid.

The projection from the WAP grid 26 to a rectangular grid 20 can be performed on relatively small portions of the data. In the linear parts of the swath 18 the WAP grid 26 will be similar to a rectangular grid 20 from the start, so a projection will most likely give very small changes. In the curved parts of the swath however, even short segments being projected will have some curvature. The rectangular grid will in such cases first be placed to form a best fit with the WAP grid. Next, it will be projected onto the rectangular grid and visualized in the 3D and/or horizon window, or the 3D attributes will be calculated by means of existing algorithms.

The calculations along in-lines, for instance calculation of length between two points, will use real coordinates and hence don't need projection.

### LINKED WINDOWS AND ZOOM INN WINDOWS

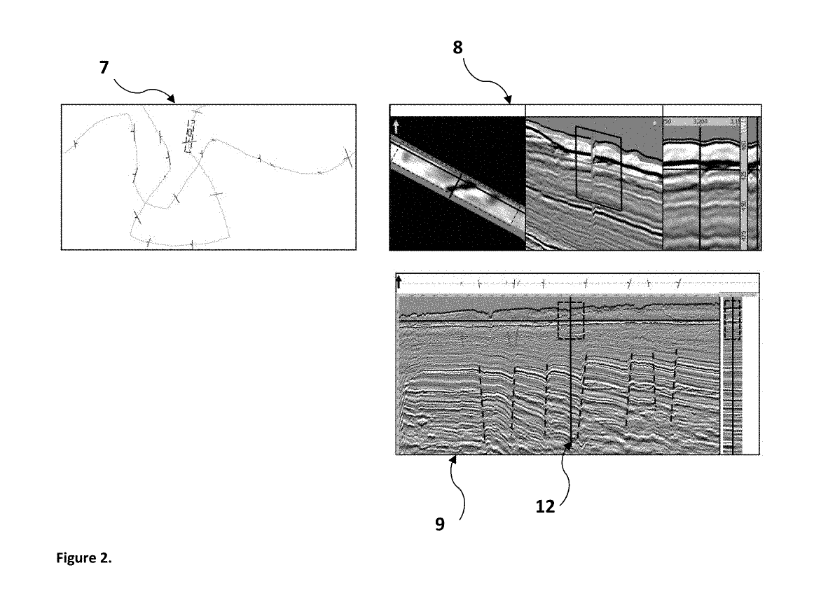

As described above, effective interpretation of WAP data is dependent on windows with very different field of view and a functioning link between the windows, giving a smooth workflow with both a good overview and a good detailed view. In common interpretation software it is possible to have several different windows (similar to window 7,,9, 15 16 , however not linked as according to the invention) open displaying the data, and the windows contain markers showing the field of view of the other windows. For instance in FIG. 2, all visualized lines are highlighted in the map window 7 and there is a marker 12 in window 9 indicating where the in- or cross-line is crossing in the vertical displays. There might also be a cursor in each window moving synchronized to help link features in multiple displays. However, for effective visualization of WAP data, a more extensive link is needed between the windows.

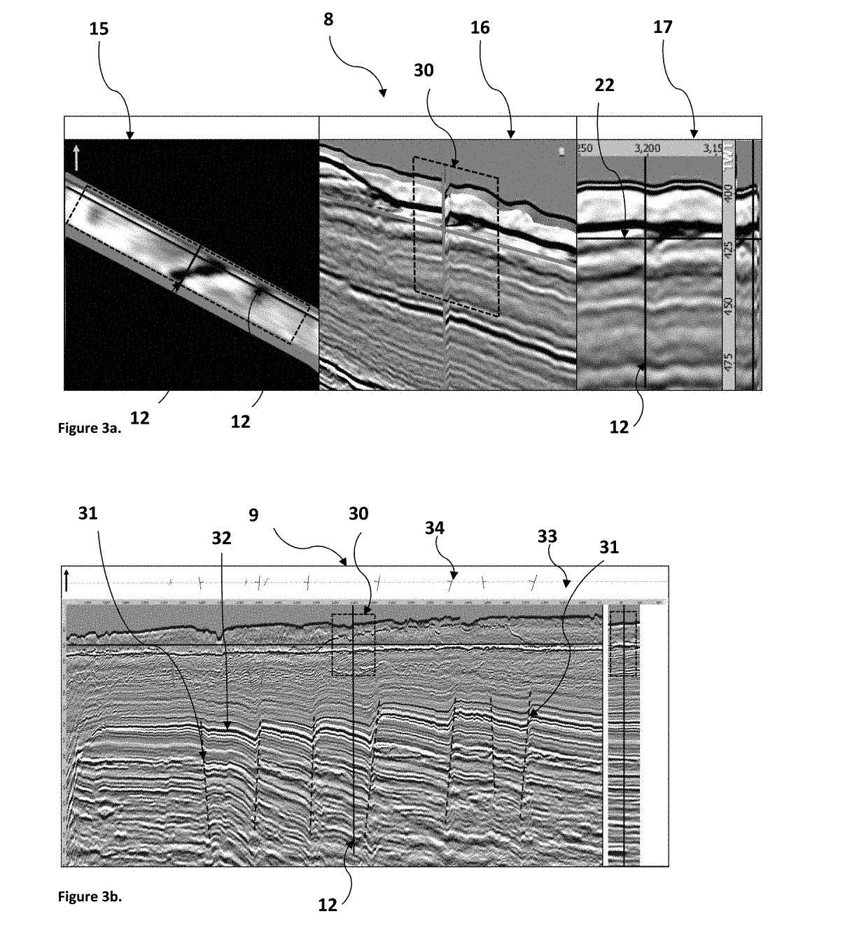

FIG. 3a shows a set of zoom inn windows 8 that have been developed to display the WAP data with a field of view of only a few hundred meters. These windows 8 are horizontal view window 15 showing time slices and horizons, a 3D viewer window 16 for volume/cube view and two vertical displays 17, one for in-lines 1 and one for cross-lines 2. The windows 8 are linked, which provides the benefit of always showing the same portion of the data. When the interpreter navigates along the swath in one window the content of the other windows automatically navigates similarly. The angle of view in the 3D window 16 and the depth of the time slice 22 should be set manually, but the content of the windows 8 will move along the swath similarly to the other windows. The regular vertical panel 9 shown in FIG. 3b, showing the in-lines in a more regional scale, is also linked to the zoom windows 8 in the same way.

In the window 8 and the window 9, there is also a marker 30 showing the field of view of the zoom inn vertical panel 17, this marker 30 can be used to move the field of view of the zoom inn windows 8. This ability is useful as WAP data is commonly interpreted for interesting features 31, 32 in detail, and when moving to the next features the interpreter will save time when not having to zoom in and out. To synchronize the field of view of the linked zoom windows 8 they use the same bin as the centre of the field of view in all the linked windows. When the interpreter navigates in one window and then changes what bin (bin number (in-line and cross-line combination)) is in the centre of the window, the other linked windows also change their field of view in order to centre the same bin in the windows.

### 3D ATTRIBUTE VISUALIZATION

When 3D attributes are interpreted in the WAP data they should be effectively visualized. One way of visualization is to display properties of interpreted 3D attributes in a panel 33 above the vertical panels 9 showing the seismic data (in-lines) and in the map windows 7. As an example, visualization of properties of interpreted faults 31 is described. Visualization of 3D attributes should however not be limited to fault properties, all interpreted 3D properties, manually or automatically interpreted, could be visualized in conjunction with both the vertical panels 9 and map windows 7. Example of 3D attributes may be boulders, gas, amplitude anomalies, plowmarks horizons and pockmarks. Properties 34 of faults 31 to be displayed can be offset, strike, dip, depth and age. The standard way of displaying properties of fault 31 is a line 34 where the length of the line is representing the offset, the tilt of the line is representing the strike, and usually a shorter line attached normal to the centre of the main line represents the dip. Color coding can represent depth or age.

When a fault 31 is interpreted in the visualization software with standard fault interpretation tools, the fault 31 can be displayed both in conjunction with the vertical panel 9 and in the map window 7. The symbols which are used to display the fault properties 34 are the same in both the map view 7 and in the vertical panel 9 where the fault properties 34 are visualized in the panel 33 above the fault 31 in the seismic data. This fault property 34 visualization window is linked such that it will move with the seismic when the interpreter navigates through the data. The strike of the data is represented by the tilt of the main line, and the tilt will be relative to a reference direction that can be set by the interpreter. The orientation can be fixed or relative to the seismic line.

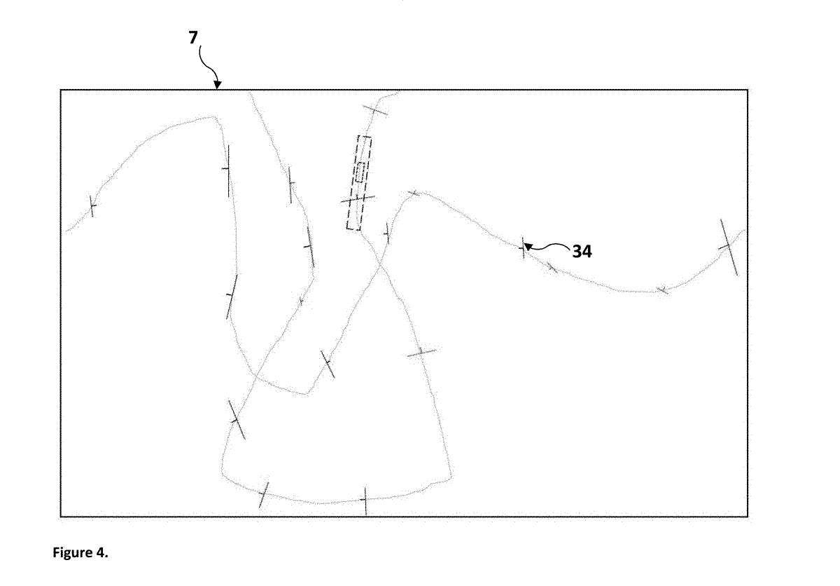

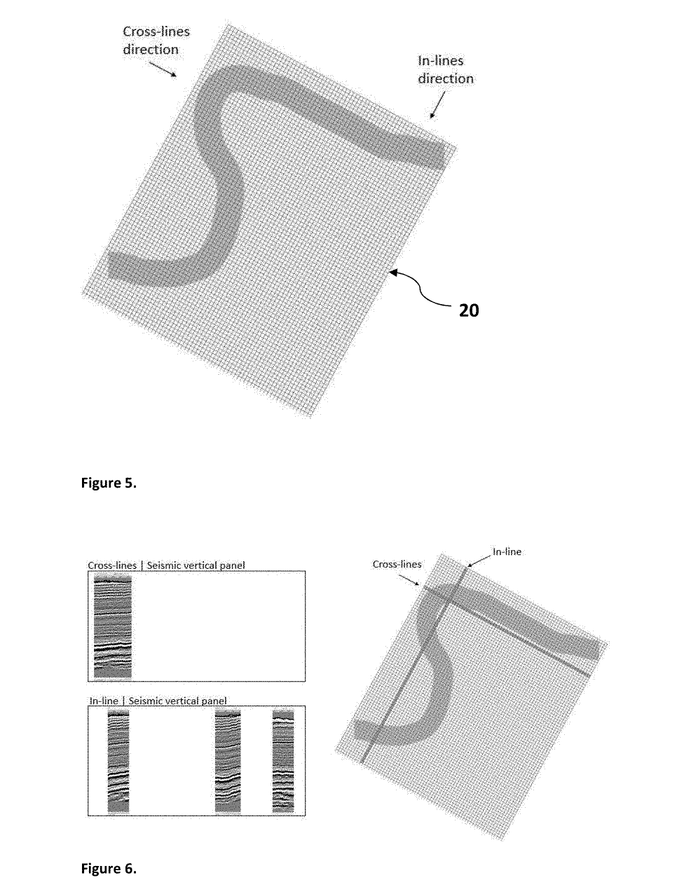

In the map window as shown in FIG. 4, the fault property 34 visualization is particularly useful when viewing the window 7 on a regional scale. The 3D information in the WAP data gives the ability to interpret attributes in detail in zoom windows and then visualize them in large areas in the map window, this gives the ability to map and arrange faults 31 into systems, this ability has not been possible before without having complete 3D data covering the whole region.

When the faults 31 are interpreted they are assigned a position on the centre in-line. The faults 31 are also assigned a strike value, dip value, offset value, and depth and/or age value. The faults 31 are then visualized in the map window 7 at their centre in-line location with the same symbols as in the vertical panel 9.

One great advantage with WAP data is the 3D information possible to extract, such as strike and dip of faults. To visualize and interpret these attributes effectively they can be displayed in panels in conjunction with both vertical seismic panels and map windows. This advantage is shown in FIGS. 3b and 4 where strike and dip of interpreted faults 31 are displayed both above a vertical seismic panel, showing the current in-line, and in a map window 7, showing data with a regional field of view which renders the WAP swath into a thin line.

The invention is developed to be utilized with WAP data acquired by the P-Cable™ high-resolution 3D seismic system. However, it is not limited in any way to only WAP data or data acquired with the P-Cable system. Any seismic data with parallel lines or data from other imaging techniques such as sub bottom profiler data and multibeam data could also benefit from the invention.

While the invention has been described with reference to the illustrated embodiment, those skilled in the art will readily appreciate that many modifications are possible in the embodiments without materially departing from the novel teaching and advantages of this invention.

1. A data visualization method for visualizing data acquired along a non-linear acquisition path or sail line, the data consists of CMP lines that follow the non-linear acquisition path, the data is arranged such that the in-lines in the binning grid follow the acquisition path and the cross-lines are perpendicular, or near perpendicular, to the in-lines, the method comprising the steps of:
creating a binning grid covering the CMP lines of the acquired data, the binning grid comprising a straight portion and a curved portion;
calculating bins for each portion;
loading the seismic data into the a visualization software; and
creating a set of linked windows, wherein a field of view of the different linked windows is synchronized, and wherein a marker is provided to visualize the field of view of the data in at least two of the linked windows.

2. The method according to claim 1, wherein the set of linked windows show a horizontal and a vertical seismic data section, seismic data horizons and time slices, seismic data 3D view and 3D attributes.

3. The method according to claim 2, wherein in the vertical section is provided a panel for displaying the seismic 3D attributes.

4. The method according to claim 3, wherein the seismic 3D attributes comprise manually or automatically interpreted 3D properties.

5. The method according to claim 4, wherein the panel displays fault properties or properties characterizing other seismic attributes or structures.

6. The method according to claim 4, wherein the fault properties include fault offset, strike, dip, depth and age.

7. The method according to claim 1, wherein the non-linear data is displayed in full length.

8. The method according to claim 1, wherein the non-linear data is multi-beam data.

9. The method according to claim 1, wherein the non-linear data is Sub Bottom Profiler data.

10. A seismic data visualization method for visualizing seismic data acquired using a vessel; a seismic acquisition system for collecting geophysical seismic data; a marine navigation system for generating positioning data from the location of said vessel and the location of said seismic acquisition system; a seismic data storage engaged with the seismic acquisition system for collecting and storing the seismic data; a seismic data is processor engaged with said seismic data storage for seismic processing of the seismic data; wherein the seismic data has been acquired along a non-linear acquisition path or sail line; the data consists of CMP lines that follow the non-linear acquisition path; the data is arranged such that the in-lines in the binning grid follow the acquisition path and the cross-lines are perpendicular, or near perpendicular, to the in-lines at any given point, the method further comprising the steps of:
creating a binning grid covering the CMP lines of the acquired data, the binning grid comprising a straight portion and a curved portion;
calculating bins for each portion;
loading the seismic data into the a visualization software;
creating a set of linked windows, wherein a field of view of the different set of linked windows is synchronized, and wherein a marker is provided to visualize the field of view of data in at least two of the linked windows; and
displaying interpreted seismic features on a panel in at least one of the said linked windows.

11. A computer with a readable storage medium using a program of instructions executable by the computer, to perform the method of claim 1.
